(19) United States
(12) Patent Application Publication
(10) Pub. No.: US 2003/0169232 A1
(43) Pub. Date: Sep. 11, 2003

(54) Keyboard input device

(75) Inventor: Hideki Ito, Fukushima-ken (JP)

Correspondence Address: BRINKS HOFER GILSON & LIONE, P.O. BOX 10395, CHICAGO, IL, 60611, US

(73) Assignee: Alps Electric Co., Ltd.

(21) Appl. No.: 10/383,472

(22) Filed: Mar. 6, 2003

(30) Foreign Application Priority Data
Mar. 7, 2002 (JP) 2002-062737

(51) Int. Cl. G09G 5/00

(52) U.S. Cl. 345/156

(57) ABSTRACT

A keyboard input device of the present invention comprises a circuit substrate having a plurality of fixed contacts formed thereon, a rubber spring with a hollow therein provided on the contacts, a key top that can be urged by elastic-urging force of the rubber spring in a direction away from the circuit substrate, and a base plate provided under the circuit substrate. The rubber spring is bonded to the circuit substrate and the contacts are positioned in the hollow, a first ventilating hole penetrating the circuit substrate is provided so that the first ventilating hole is positioned in the hollow, and opposing surfaces of the circuit substrate and the base plate are bonded to each other by an adhesive.

### BACKGROUND OF THE INVENTION

1. Field of the Invention

The present invention relates to a keyboard input device. In particular, the present invention relates to a keyboard input device used as an inputting device of a personal computer or the like.

2. Description of the Related Art

Generally, a low-profile keyboard input device used for a notebook PC or the like includes key-tops. Each of the key-tops is elastically urged in an upward direction by a hollow rubber spring. A pair of cross-linked levers are provided for each of the key-tops and are used as holding members thereof. As the key-top goes up and down, the angle at which the levers are cross-linked varies. There have been proposed various types of keyboard input devices having the above-described configuration.

For example, in one of the above-described keyboard input devices, the upper end of one of the levers is rotationally engaged with the underside of the key top. Further, the upper end of the other lever is slidably engaged with the underside of the key top. These levers are linked with each other at the position where they cross each other so that they are integrated. This pair of integrated levers support the key top so that the key top can move upward and downward.

As shown in FIG. 3, a switch unit of the above-described keyboard input device includes a hollow rubber spring 21 having a dome shape. A ceiling 21a in the hollow of the rubber spring 21 has a movable contact 21b.

The rubber spring 21 has a skirt-like rim 21c. The perimeter of a lower end 21d of the rim 21c is bonded to a switch substrate 23 by an adhesive 22.

One surface of the switch substrate 23 is opposed to the movable contact 21b. A pair of fixed contacts 23a are formed on the surface and are switched on and off by contact with the movable contact 21b.

A ventilating opening 23b with a predetermined diameter is formed in the switch substrate 23 at the position between the pair of fixed contacts 23a so that the ventilating opening 23b penetrates the switch substrate 23. Further, a plurality of openings is formed in the switch substrate 23 at the positions where the rubber spring 21 should not be bonded so that cut and raised parts of a metal plate 25 that will be described later can be inserted therein.

A lever mounting plate (not shown) is placed on the switch substrate 23 at the position where the rubber spring 21 is bonded. On the lever mounting plate, a pair of cross-linked levers (not shown) are mounted so that they can move upward and downward.

A spacer member 24 having a predetermined thickness is provided under the switch substrate 23. As shown in FIG. 4, a ventilating slot 24a is provided in the spacer member 24 at the position where the ventilating hole 23b is provided. Consequently, when the rubber spring 21 is elastically deformed, the air in the hollow of the rubber spring 21 can flow outside. Further, the air outside the rubber spring 21 can flow into the rubber spring 21.

The switch substrate 23 and the spacer member 24 are placed on the metal plate 25, which is flat. The metal plate 25 has cut and raised parts 25a at the outer region thereof. The switch substrate 23 and the spacer member 24 extend to the rim of the cut and raised part 25a.

The metal plate 25 is housed in a casing 26.

A plurality of electronic parts (not shown) such as semiconductor devices, resistors, and so forth are mounted on a base plate 26a of the casing 26. The metal plate 25, which is housed in the casing 26, is provided above the plurality of electronic parts, with a predetermined gap interposed therebetween.

In the case of the above-described known keyboard input device, when a key top 27 on the rubber spring 21 is pressed down, the rim 21c of the rubber spring 21 is elastically deformed and the movable contact 21b goes down.

Consequently, the air in the hollow of the rubber spring 21 flows from the ventilating opening 23b to the ventilating slot 24a of the spacer member 24. Therefore, the rubber spring 21 can elastically deformed without resistance and the movable contact 21b comes into contact with the pair of fixed contacts 23a so that the switch unit is turned on.

Further, when the key top 27 is pressed, the rubber spring 21 is elastically deformed and the air in the hollow thereof is compressed. However, the compressed air can easily flow to the ventilating slot 24a via the ventilating opening 23b.

Consequently, the key top 27 can be pressed down without resistance so that it can move downward. Therefore, the operability of the key top is increased.

However, in the case of the above-described keyboard input device, the spacer member 24 and the switch substrate 23 are simply placed on the metal plate 25. Therefore, if a user spills liquid such as a beverage or the like over the key top 27 by mistake, the spilt liquid is prevented from going down by the cut and raised part 25a. However, since the spilt liquid remains inside the cut and raised part 25a, the liquid may flow into the ventilating slot 24a or into the gap between the switch substrate 23 and the spacer member 24 from a positioning hole (not shown) provided in the switch substrate 23. In such a case, the liquid may eventually reach the fixed contacts 23a and cause the fixed contacts 23a to short out, thereby causing the keyboard input device to fail.

### SUMMARY OF THE INVENTION

Accordingly, it is an object of the present invention to provide a keyboard input device capable of keeping out water, which can cause the keyboard input device to fail. That is to say, when a user spills liquid such as a beverage or the like on the key tops of the keyboard input device by mistake, the spilt liquid is prevented from entering a gap between a switch substrate and a metal plate placed thereunder.

A keyboard input device according to an aspect of the present invention comprises a switch sheet having a plurality of contacts thereon, a rubber spring with a hollow therein provided on the plurality of contacts, a key top that can be urged by elastic-urging force of the rubber spring in a direction away from the switch sheet, and a base plate provided under the switch sheet. The rubber spring is bonded to the switch sheet and the contacts are positioned in the hollow. A first ventilating hole penetrating the switch sheet is provided so that the first ventilating hole is positioned in the hollow. Further, opposing surfaces of the switch sheet and the base plate are bonded to each other by an adhesive. Therefore, when a user spills water or the like on the circuit substrate by mistake, the water is prevented from falling and getting under the base plate. That is to say, the keyboard input device has a waterproof function for preventing the deterioration or the like of the electronic parts caused by the water.

Preferably, the base plate has a second ventilating hole penetrating the base plate at a predetermined part opposing the first ventilating hole. Therefore, when the rubber spring is elastically deformed, the air in the hollow can smoothly flow outside.

Consequently, the keyboard input device is easy to operate.

Preferably, the entire opposing surfaces of the switch sheet and the base plate are bonded to each other. Therefore, if the circuit substrate has a plurality of holes therein, the holes are sealed with the adhesive. Accordingly, the circuit substrate becomes waterproof.

Preferably, the plurality of contacts includes a pair of fixed contacts formed on the switch sheet. The pair of fixed contacts are opposed to each other with a predetermined gap interposed therebetween. The first ventilating hole is provided between the pair of fixed contacts. Therefore, electrical isolation can be provided between the pair of fixed contacts.

Further, the air in the rubber spring can easily flow outside from the first ventilating hole via the second ventilating hole.

### BRIEF DESCRIPTION OF THE DRAWINGS

FIG. 1 is a sectional view of the main parts of a keyboard input device according to the present invention;

FIG. 2 schematically shows how a lever-mounting plate is mounted on a sheet switch according to the present invention;

FIG. 3 schematically shows how a known sheet switch is mounted; and

FIG. 4 schematically shows a ventilating opening in the known sheet switch.

### DESCRIPTION OF THE PREFERRED EMBODIMENTS

A keyboard input device according to the present invention will be described with reference to the attached drawings.

The keyboard input device has a plurality of key switches placed in alignment. FIG. 1 shows one of the key switches. As shown in the drawing, a key top 1 formed by a resin material or the like is provided on the top of the key switch. An operational surface 1a that can be pressed by a finger or the like is formed on the upper surface of the key top 1.

Further, an actuator 2 formed by a metal plate such as a stainless-steel plate or the like is engaged with the lower surface of the key top 1.

The actuator 2 has a rotatably-engaging part 2a formed by bending the right end of the actuator 2 so that the right end becomes a substantially U-shaped. Further, the actuator 2 has a slidingly-engaging part 2b formed by bending the left end of the actuator 2 so that the left end becomes substantially U-shaped.

As shown in the drawing, the rotatably-engaging part 2a and the slidingly-engaging part 2b open leftward. That is to say, the rotatably-engaging part 2a and the slidingly-engaging part 2b open in the same direction.

An upper end 3a of a first lever 3 is rotatably engaged with the rotatably-engaging part 2a. An upper end 4a of a second lever 4 is slidably engaged with the slidingly-engaging part 2b.

The first and second levers 3 and 4 are cross-linked. A linking pin 4b provided at the position where the first and second levers 3 and 4 are cross-linked acts as a pivot of the levers. Consequently, the upper ends 3a and 4a can move upward and downward.

A lower end 3b of the first lever 3 and a lower end 4c of the second lever 4 are held by a lever-mounting plate 5.

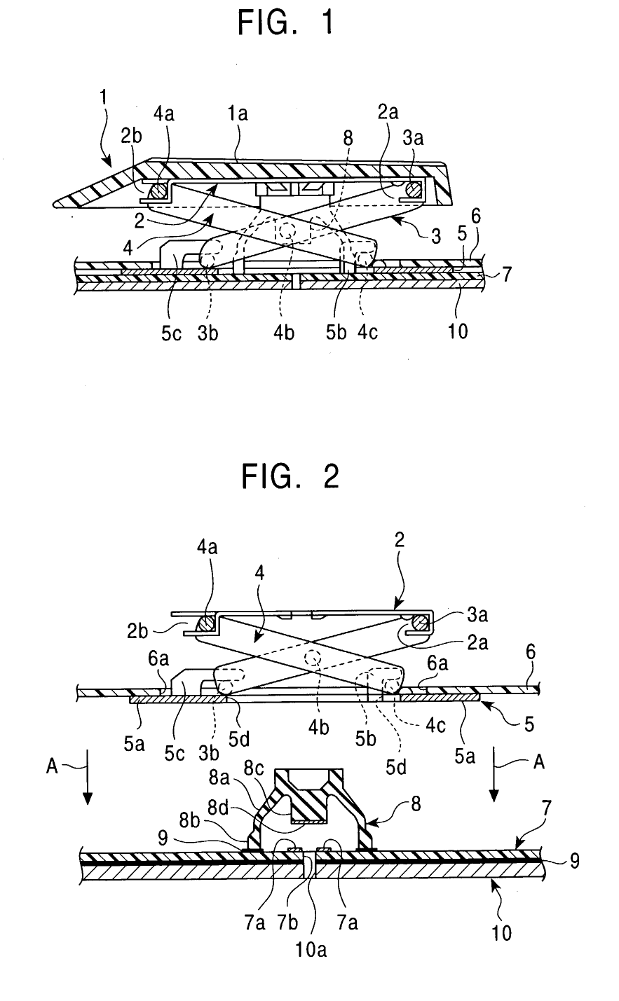

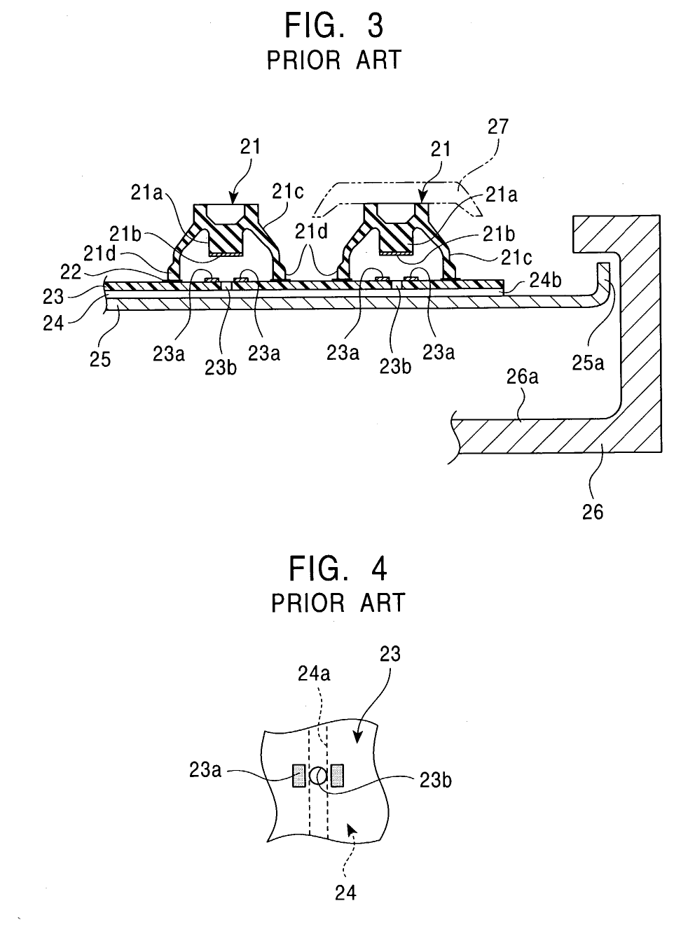

The lever-mounting plate 5 is formed by a metal plate made of stainless steel or the like. As shown in FIG. 2, the lever-mounting plate 5 has a flat and substantially rectangular substrate 5a formed by presswork or the like. Further, the right end of the substrate 5a is cut and raised, and a substantially L-shaped rotation-locking part 5b is formed. The lower end 4c of the second lever 4 is rotatably engaged with the rotatably-engaging part 5b.

Further, the left end of the substrate 5a is cut and raised, and a substantially L-shaped slidingly-engaging part 5c is formed. The lower end 3b of the first lever 3 is slidably engaged with the slidingly-engaging part 5c.

At approximately the center of the substrate 5a, a circular hole 5d into which one of a plurality of rubber springs 8 that can be inserted is provided. The details of the rubber springs 8 will be described later.

The rotation-locking part 5b and the slide-locking part 5c open rightward. That is to say, the rotation-locking part 5a and the slide-locking part 5c open in the same direction.

The lever-mounting plate 5 is temporarily engaged with a holding plate 6 so that they are integrated.

The holding plate 6 has an opening 6a for temporarily engaging the lever-mounting plate 5 with the holding plate 6. When the rotation-locking part 5b and the slide-locking part 5c are inserted into the opening 6a from below, a snap-locking part (not shown) formed on the lever-mounting plate 5 is snapped and engaged with the opening 6a so that the lever-mounting plate 5 is prevented from slipping down. Further, the right and left ends of the substrate 5a come in contact with the lower surface of the holding plate 6, and thus the lever-mounting plate 5 is prevented from going upward.

A circuit substrate 7 is provided under the lever-mounting plate 5, which is temporarily engaged with the holding plate 6. A plurality of contacts is formed on one surface of the circuit substrate 7.

The plurality of contacts includes a pair of opposing fixed contacts 7a which are separated from each other by a predetermined gap. A first ventilating hole 7b penetrating the circuit substrate 7 is provided between the fixed contacts 7a.

One of the rubber springs 8, which have a dome shape, is provided over the pair of fixed contacts 7a.

The rubber spring 8 is hollow and has a skirt-like rim 8a. The perimeter of a lower end 8b of the rim 8a is bonded to the circuit substrate 7 by an adhesive 9. Consequently, the circuit substrate 7 and the rubber spring 8 are integrated.

Further, a ceiling 8c is provided in the hollow of the rubber spring 8. The ceiling 8c has a movable contact 8d including carbon or the like. The movable contact 8d has a predetermined width and opposes the pair of fixed contacts 7a.

The plurality of rubber springs 8 is bonded and integrated with the circuit substrate 7. The circuit substrate 7 is placed on a base plate 10 formed by a metal plate including aluminum or the like. The base plate 10 has a penetrating second ventilating hole l0a. The second ventilating hole 10a opposes the first ventilating hole 7b of the circuit substrate 7.

The base plate 10 has a plurality of projection parts (not shown) for preventing the lever-mounting plate 5, which is temporarily engaged with the holding plate 6, from moving. The projection parts can be inserted into a plurality of holes formed in the circuit substrate 7.

One of the surfaces of the circuit substrate 7 opposes the base plate 10. The entire surface opposing the base plate 10 is bonded to the base plate 10 by the adhesive 9.

Then, the base plate 10 is housed in a casing (not shown) and is mounted on a base plate (not shown) of the casing.

A plurality of electronic parts such as semiconductor devices, resistors, and so forth are mounted on the base plate of the casing. The base plate 10, which is housed in the casing, is provided above the plurality of electronic parts, with a predetermined gap interposed therebetween.

As shown in FIG. 2, the lower surface of the circuit substrate 7, on which the rubber springs 8 are mounted, opposes the base plate 10. The adhesive 9 is applied to the entire the lower surface of the circuit substrate 7. Then, the circuit substrate 7 is placed on the base plate 10 and is bonded thereto.

Then, the lever-mounting plate 5 is snapped in the opening 6a of the holding plate 6 so that the lever-mounting plate 5 is temporarily engaged with the holding plate 6. After that, the first lever 3 is inserted in the slide-locking part 5c and the second lever 4 is inserted in the rotation-locking part 5b. The actuator 2 is mounted on the upper ends 3a and 4a.

The lever-mounting plate 5, which is temporarily engaged with the holding plate 6, is adjusted so that the hole 5d is aligned with the rubber spring 8 thereunder. Then, when the holding plate 6 is moved downward along a direction indicated by arrow A, the lever-mounting plate 5 is positioned on the circuit substrate 7. Further, the rubber spring 8 penetrates the hole 5d and is projected upward from the lever-mounting plate 5.

When the rubber spring 8 is elastically urged, the actuator 2 is pushed upward and the first and second levers 3 and 4 cross each other so that they have an X-shape.

Then, the key top 1 is mounted and engaged with the actuator 2. The keyboard input device of the present invention is assembled in this way.

When the operational surface 1a of the key top 1 is pressed down, the rim 8b of the rubber spring 8 is elastically deformed and the movable contact 8d goes down.

Subsequently, the air in the hollow of the rubber spring 8 flows downward and outside from the first ventilating hole 7b and the second ventilating hole 10a. Therefore, the rubber spring 8 can be elastically deformed smoothly without resistance.

When going down, the movable contact 8d comes into contact with the pair of fixed contacts 7a. Subsequently, a switch circuit (not shown) is switched on.

When the pressed key top 1 is released, the movable contact 8d is separated from the pair of fixed contacts 7a by the elasticity of the rubber spring 8. Then, the switch circuit is turned off and the rubber spring 8 returns to its initial state.

At that time, the outside air flows into the hollow in the rubber spring 8 via the first and second ventilating holes 7b and 10a. Consequently, the rubber spring 8 can easily return to its initial state.

The overall surface of the circuit substrate 7 opposing the base plate 10 is bonded to the base plate 10 by the adhesive 9. Therefore, if a plurality of holes are provided in the circuit substrate 7, the holes can be shielded by the adhesive 9 so that liquid or the like that is spilt on the circuit substrate 7 is prevented from flowing into the casing.

Consequently, when a user spills water or the like on the circuit substrate 7 by mistake, the water is prevented from falling on the electronic parts, which are provided under the base plate 10.

According to the above-described embodiment of the present invention, the entire opposing surfaces of the circuit substrate 7 and the base plate 10 are bonded to each other. However, alternatively, only the plurality of holes, which is provided in the circuit substrate 7, is sealed with the adhesive 9.

Further, according to the above-described embodiment, the pair of fixed contacts 7a are formed on a single circuit substrate 7. However, the circuit substrate may be formed by two membrane sheets and each of the contacts may be formed on each of the membrane sheets so that the contacts oppose each other. Further, the rubber spring 8 need not have the movable contact 8d.

The base plate 10 according to the above-described embodiment is formed by a metal plate made of aluminum. However, the base plate 10 may be formed by molding resin material or the like.

What is claimed is:

1. A keyboard input device comprising:
a switch sheet having a plurality of contacts thereon;
a rubber spring with a hollow therein provided on the plurality of contacts;
a key top that can be urged by elastic-urging force of the rubber spring in a direction away from the switch sheet; and
a base plate provided under the switch sheet,
wherein the rubber spring is bonded to the switch sheet and the contacts are positioned in the hollow, a first ventilating hole penetrating the switch sheet is provided so that the first ventilating hole is positioned in the hollow, and opposing surfaces of the switch sheet and the base plate are bonded to each other by an adhesive.

2. A keyboard input device according to claim 1, wherein the base plate has a second ventilating hole penetrating the base plate at a predetermined part opposing the first ventilating hole.

3. A keyboard input device according to claim 1, wherein the entire opposing surfaces of the switch sheet and the base plate are bonded to each other.

4. A keyboard input device according to claim 1, wherein the plurality of contacts includes a pair of fixed contacts formed on the switch sheet, the pair of fixed contacts being opposed to each other with a predetermined gap interposed therebetween, and wherein the first ventilating hole is provided between the pair of fixed contacts.
